(19) United States
(12) Patent Application Publication
(10) Pub. No.: US 2025/0300205 A1
(43) Pub. Date: Sep. 25, 2025

(54) REGENERATIVE FUEL CELL SYSTEM

(71) Applicant: HONDA MOTOR CO., LTD., TOKYO (JP)

(72) Inventors: Takumi KAWANO, WAKO-SHI (JP); Koki TAMURA, WAKO-SHI (JP)

(21) Appl. No.: 19/061,097

(22) Filed: Feb. 24, 2025

(30) Foreign Application Priority Data
Mar. 19, 2024 (JP) 2024-043508

(51) Int. Cl. H01M 8/04746; H01M 8/04082; H01M 8/04119; H01M 8/0438; H01M 8/04537; H01M 8/0656

(52) U.S. Cl. CPC H01M 8/04753; H01M 8/04164; H01M 8/04197; H01M 8/04201; H01M 8/04388; H01M 8/04582; H01M 8/04611; H01M 8/0656

(57) ABSTRACT

When executing a depressurizing process of a hydrogen compression device and a water electrolysis device, on-off valves that supply a hydrogen gas or an oxygen gas to a fuel cell are placed in an opened state, and further, a set pressure of supply pressure reducing valves are adjusted to a value that is lower than a set pressure of bypass pressure reducing valves. Gas remaining in gas depressurizing regions is supplied, via the bypass pressure reducing valves, to the fuel cell.

### CROSS-REFERENCE TO RELATED APPLICATIONS

This application is based upon and claims the benefit of priority from Japanese Patent Application No. 2024-043508 filed on Mar. 19, 2024, the contents of which are incorporated herein by reference.

### BACKGROUND OF THE INVENTION

### Field of the Invention

The present invention relates to a regenerative fuel cell system.

### Description of the Related Art

In recent years, in order to make it possible for more people to be capable of relying thereon at an affordable cost, and to ensure access to sustainable and advanced energy, research and development have been conducted in relation to fuel cells that contribute to energy efficiency. In JP 7393450 B2 (hereinafter referred to as the prior art publication), a regenerative fuel cell system 110 shown in FIG. 7 is disclosed.

This regenerative fuel cell system 110 is basically constituted by a fuel cell 112, a water tank (a water supply apparatus) 126, a water electrolysis apparatus 122, a hydrogen pressurizing apparatus 124, an oxygen tank 142A, a hydrogen tank 142B, a gas-liquid separator 130, and a control apparatus 118 that serves to control these constituent elements.

In such a regenerative fuel cell system 110, the water electrolysis apparatus 122 and the hydrogen pressurizing apparatus 124 are normally made to operate in a state with power generation by the fuel cell 112 being stopped, and a predetermined amount of gas is filled into the oxygen tank 142A and the hydrogen tank 142B.

While operating in this manner, the water electrolysis apparatus 122 electrolyzes water that is supplied from the water tank 126 through the gas-liquid separator 130, and thereby generates high pressure oxygen and low pressure hydrogen.

The high pressure oxygen generated by the water electrolysis apparatus 122 passes through a branch portion BP and a gas-liquid separator 164A, and is stored in the oxygen tank 142A.

The low pressure hydrogen generated by the water electrolysis apparatus 122 passes through the gas-liquid separator 130 and is supplied to the hydrogen pressurizing apparatus 124.

The hydrogen pressurizing apparatus 124, while operating in this manner, pressurizes the low-pressure hydrogen into a high pressure hydrogen. The pressurized high pressure hydrogen passes through the branch portion BP and a gas-liquid separator 164B, and is stored in the hydrogen tank 142B.

When the oxygen tank 142A and the hydrogen tank 142B are filled with the predetermined amount of gas due to the water electrolysis apparatus 122 and the hydrogen pressurizing apparatus 124 being operated, a depressurizing process of the water electrolysis apparatus 122 and the hydrogen pressurizing apparatus 124 is carried out.

In such a depressurizing process, the high pressure oxygen, which remains at the outlet of the water electrolysis apparatus 122 and a communication path thereof, and the high pressure hydrogen, which remains at the outlet of the hydrogen pressurizing apparatus 124 and a communication path thereof, are supplied to the fuel cell 112.

The fuel cell 112 consumes the oxygen and the hydrogen that have been supplied, by way of an electrochemical reaction, and charges a battery 120 by power generated thereby. In this manner, a depressurizing process (a pressure reducing process) of the water electrolysis apparatus 122 and the hydrogen pressurizing apparatus 124 is executed. After the execution of the depressurizing process, the operation of the water electrolysis apparatus 122 and the hydrogen pressurizing apparatus 124 is stopped.

Thereafter, the fuel cell 112 can continue to perform power generation by way of an electrochemical reaction between the oxygen supplied from the oxygen tank 142A and the hydrogen supplied from the hydrogen tank 142B.

When the water electrolysis process by the water electrolysis apparatus 122 and the pressurizing process by the hydrogen pressurizing apparatus 124 are made to stop without executing the aforementioned depressurizing process, the high pressure hydrogen generated in the hydrogen pressurizing apparatus 124 cross-leaks within the hydrogen pressurizing apparatus 124. The cross-leaked hydrogen flows back into the gas-liquid separator 130 and causes the hydrogen pressure inside the gas-liquid separator 130 to rise.

When the pressure of the hydrogen inside the gas-liquid separator 130 rises to be greater than or equal to a threshold pressure value, a relief valve (not shown) provided in the gas-liquid separator 130 opens, and thereby causes the hydrogen, which is a circulating medium, to be discharged to the exterior.

Further, when the water electrolysis process by the water electrolysis apparatus 122 and the pressurizing process by the hydrogen pressurizing apparatus 124 are made to stop without executing the aforementioned depressurizing process, the high pressure oxygen generated in the water electrolysis apparatus 122 cross-leaks within the water electrolysis apparatus 122. The cross-leaked oxygen flows back into the gas-liquid separator 130 and causes the oxygen pressure inside the gas-liquid separator 130 to rise.

When the pressure of the oxygen inside the gas-liquid separator 130 rises to be greater than or equal to a threshold pressure value, a relief valve (not shown) provided in the gas-liquid separator 130 opens, and thereby causes hydrogen and oxygen, which is a circulating medium, to be discharged to the exterior. Thus, in the regenerative fuel cell system 110, the depressurizing process is necessary.

In order to execute an appropriate depressurizing process, flow regulating valves 160A and 160B are provided in the regenerative fuel cell system 110 disclosed in the prior art publication.

At the time of the depressurizing process, the control apparatus 118 calculates an amount of pressure reduction per unit time (a depressurization rate) of the pressure detected by pressure sensors 162A and 162B. The control apparatus 118 controls the flow rates of the flow regulating valves 160A and 160B, and thereby executes the depressurizing in a manner so that the difference between a measured depressurization rate and the target depressurization rate becomes small.

Further, in the regenerative fuel cell system 110 disclosed in the prior art publication, the opening and closing of first on-off valves 146A and 146B and second on-off valves 148A and 148B is finely and precisely controlled, in order to eliminate any discrepancy in the timing of the completion of the depressurizing of the high pressure oxygen and the high pressure hydrogen.

By supplying into a fuel cell 22 the oxygen or the hydrogen which has been subjected to earlier completion of depressurizing, from the oxygen tank 142A or the hydrogen tank 142B, power generation in the fuel cell 112 is allowed to continue, and a control is carried out in order to consume the gas which has not yet been subjected to completion of depressurizing (refer to paragraph to paragraph of the prior art publication).

### SUMMARY OF THE INVENTION

However, in the aforementioned conventional depressurizing process (depressurizing technique), there are the following first to third problems.

### First Problem

In a depressurizing control which makes use of the flow regulating valves 160A and 160B to control the flow rate, a primary pressure and a secondary pressure of the flow regulating valves 160A and 160B fluctuate, and therefore, it is impossible to accurately control the flow rate. Accordingly, it is difficult to accurately control the actual depressurization rate in a manner so as to coincide with a target pressurization rate.

### Second Problem

Under a circumstance in which, during the depressurizing process, a difference in pressure occurs in the respective stacks of the water electrolysis apparatus 122 and the hydrogen pressurizing apparatus 124, cross-leaking of gas occurs via an electrolyte membrane from a high pressure side to a low pressure side of each stack. Due to such cross-leaking, as a result of the pressure on the low pressure side in the stack rising, the pressure inside the gas-liquid separator 130 rises, whereby a relief valve (not shown) provided in the gas-liquid separator 130 is subjected to opening, so that the gas is discharged to the exterior, thereby resulting in a loss of the gas.

### Third Problem

As a result of the difference in timing between the completion of the depressurizing of the oxygen and the completion of the depressurizing of the hydrogen, the opening and closing of the first on-off valves 146A and 146B and the second on-off valves 148A and 148B is controlled. However, such an opening and closing control becomes extremely complicated.

The present invention has the object of solving the aforementioned problems.

An aspect of the present invention is characterized by a regenerative fuel cell system including a fuel cell configured to carry out power generation by an electrochemical reaction between oxygen gas and hydrogen gas, a compression device (a pair of a hydrogen compression device and an oxygen compression device) configured to generate either one of a pressurized oxygen gas or a pressurized hydrogen gas, a supply mechanism (two supply mechanisms) configured to supply the gas to the fuel cell, and a control device, wherein the supply mechanism includes a gas supply path configured to supply the gas from the compression device to the fuel cell, a tank disposed on the gas supply path, and configured to store the gas that has been pressurized by the compression device, a bypass path configured to branch off from a branching portion of the gas supply path between the compression device and the tank, and to merge into a merging portion of the gas supply path between the tank and the fuel cell, a supply pressure reducing valve disposed in the gas supply path between the tank and the merging portion, a bypass pressure reducing valve disposed in the bypass path, and an on-off valve configured to allow the gas to be supplied to the fuel cell, wherein the control device, in the case that a pressurizing stop operation by the compression device is started, stops supply of the gas to the tank and places the on-off valve in a valve open state, and lowers a set pressure of the supply pressure reducing valve when in the valve open state to be lower than a set pressure of the bypass pressure reducing valve, and executes a depressurizing process of the compression device.

In accordance with the above-described aspect, when executing the depressurizing process of the compression devices, the on-off valves that supply the gas to the fuel cell are placed in an opened state, and the set pressures of the supply pressure reducing valves are set to be lower than the set pressures of the bypass pressure reducing valves. Thus, the gas that remains in the gas depressurizing regions of the compression devices can be supplied to the fuel cell via the bypass pressure reducing valves. The fuel cell consumes the gas by way of an electrochemical reaction and thereby generates electrical power.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram showing a regenerative fuel cell system according to an embodiment;

FIG. 2 is a time chart in relation to a depressurizing process;

FIG. 3 is an explanatory diagram of an oxygen depressurizing region and a hydrogen depressurizing region;

FIG. 4 is an explanatory diagram of an operation of converting oxygen and hydrogen, which have cross-leaked from a high pressure side to a low pressure side at a time of a depressurizing process, into water by an oxygen removal catalyst;

FIG. 5 is an explanatory diagram of a set pressure of a pressure reducing valve in a first half of the depressurizing process;

FIG. 6 is an explanatory diagram of a set pressure of a pressure reducing valve in a latter half of the depressurizing process; and

FIG. 7 is a schematic diagram showing a conventional regenerative fuel cell system for the purpose of describing problems of a conventional method.

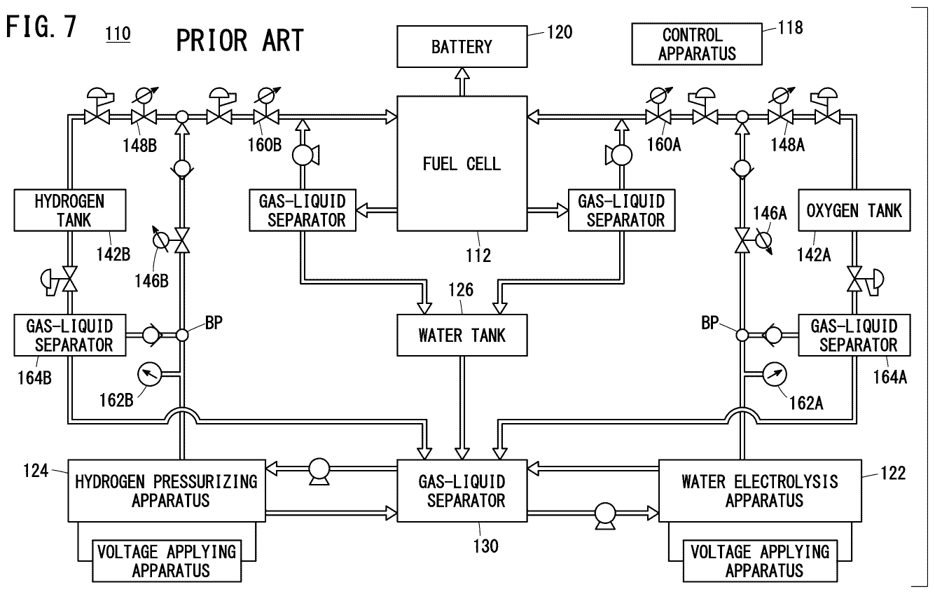

### DETAILED DESCRIPTION OF THE INVENTION

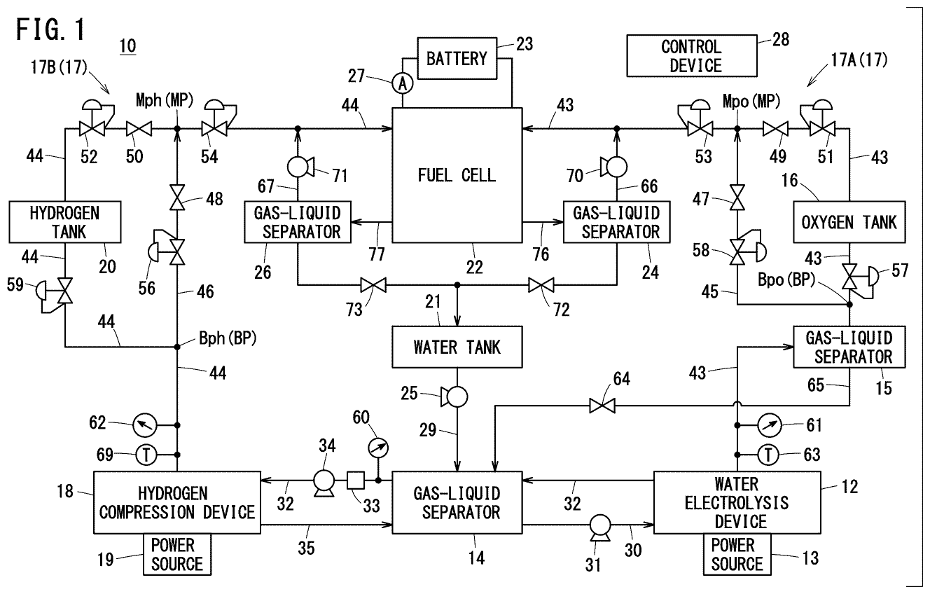

FIG. 1 is a schematic diagram showing a regenerative fuel cell system (regenerative fuel cell system: RFC) 10 according to an embodiment. The regenerative fuel cell system 10 is used, for example, in a vacuum space, such as in outer space, or the lunar surface or the like. The regenerative fuel cell system can also be used in the atmosphere.

### [Overall Description of Regenerative Fuel Cell System 10]

The regenerative fuel cell system 10 basically comprises a water electrolysis device 12, a gas-liquid separator (a hydrogen gas-liquid separator) 14, a gas-liquid separator (an oxygen gas-liquid separator) 15, an oxygen tank 16, a hydrogen compression device 18, a hydrogen tank 20, a water tank 21, a fuel cell 22, a battery 23, a gas-liquid separator (an oxygen exhaust gas gas-liquid separator) 24, a gas-liquid separator (a hydrogen exhaust gas gas-liquid separator) 26, and a control device 28. The control device 28 controls all of the constituent elements of the regenerative fuel cell system 10.

In the present embodiment, the water electrolysis device 12 is a high differential pressure water electrolysis stack apparatus (hereinafter abbreviated as EC) which serves to generate, by way of electrolysis of water, an electrochemically compressed high pressure oxygen gas, and an unpressurized hydrogen gas (a low pressure hydrogen gas).

Water that is used for the electrolysis of water is supplied to the water electrolysis device 12 from the water tank 21, via a water supply path 29, a gas-liquid separator 14, and a water supply path 30.

The water supply path 29 connects the water tank 21 and the gas-liquid separator 14. A pump 25 is disposed in the water supply path 29. The pump 25 is ON/OFF controlled by the control device 28. When the pump 25 is turned ON, it imparts mechanical energy to the water that is stored in the water tank 21, and thereby supplies the water from the water tank 21 to the gas-liquid separator 14. When the pump 25 is turned OFF, the supply of the water is stopped. Similarly, all of the other pumps described below impart mechanical energy to a fluid when turned ON, and stop the flow of the fluid when turned OFF.

The water electrolysis device 12 includes one or more unit cells. Each of the unit cells includes a membrane electrode assembly (MEA) in which an electrolyte membrane is sandwiched and held between an anode and a cathode. The electrolyte membrane that is used in the water electrolysis device 12 is an anion exchange membrane in the present embodiment, although the electrolyte membrane may be a proton exchange membrane.

The water electrolysis device 12 supplies the water from the gas-liquid separator 14 to the cathode of each of the unit cells. Each of the unit cells electrolyzes the water based on a voltage applied from an electrical power source (power source) 13 to the anode and the cathode. In this case, at the anode, the high pressure oxygen gas which is pressurized (for example, in a range of from 1 to 100 MPa) is generated, and at the cathode, the unpressurized hydrogen gas is generated.

The control device 28 is capable of varying the voltage of the electrical power source 13 that is applied between the anode and the cathode. The electrical power of the electrical power source 13 may also utilize the electrical power of the battery 23.

The water electrolysis device 12 collects the high pressure oxygen gas generated in each of the unit cells, and outputs a released gas containing the collected oxygen gas through an oxygen supply path 43 to an oxygen supply mechanism 17A. Moreover, the released gas contains water vapor that is vaporized by the heat of the water electrolysis device 12 or the like.

At the same time, the water electrolysis device 12 collects the hydrogen gas generated in each of the unit cells, and surplus water (unreacted water) on which electrolysis has not been carried out, and outputs a released fluid containing the collected hydrogen gas and unreacted water to a hydrogen supply path 32. Moreover, the released fluid contains water vapor that is vaporized by the heat of the water electrolysis device 12 or the like.

The released fluid (the hydrogen gas and the unreacted water) that is output from the water electrolysis device 12 to the hydrogen supply path 32 flows into the gas-liquid separator 14. The gas-liquid separator 14 separates the released fluid into a gas component (hydrogen gas and water vapor), and a liquid component (liquid water). The gas component is supplied to the hydrogen compression device 18 by turning ON a pump 34 of the hydrogen supply path 32 that is provided on an outlet side of the gas-liquid separator 14.

A pressure sensor 60 is provided on the hydrogen supply path 32 in close proximity to the outlet of the gas-liquid separator 14, and an oxygen remover 33 is further provided between the outlet of the gas-liquid separator 14 and the inlet of the pump 34.

The oxygen remover 33 causes the oxygen gas discharged from the water electrolysis device 12 into the gas-liquid separator 14 at the time of the depressurizing process, and the hydrogen gas discharged from the hydrogen compression device 18 into the gas-liquid separator 14 at the time of the depressurizing process to react with each other by means of an oxygen removal catalyst to thereby produce water.

More specifically, at the time of the depressurizing process, the oxygen gas cross-leaks, via the electrolyte membrane, from a high-pressure side to a low-pressure side of the water electrolysis device 12. The cross-leaked oxygen gas is discharged, via the hydrogen supply path 32, into the gas-liquid separator 14. At the time of the depressurizing process, the hydrogen gas cross-leaks, via the electrolyte membrane, from the high pressure side to the low pressure side of the hydrogen compression device 18. The cross-leaked hydrogen gas is discharged via a hydrogen discharge path 35 into the gas-liquid separator 14. The control device 28 turns the pump 34 ON. When the pump 34 is turned ON, the cross-leaked oxygen gas and the cross-leaked hydrogen gas flow through the interior of the hydrogen supply path 32. Then, the oxygen remover 33 causes the oxygen gas and the hydrogen gas to react with each other by means of the oxygen removal catalyst to thereby produce water.

The hydrogen compression device 18 includes a membrane electrode assembly (MEA) in which an electrolyte membrane is sandwiched and held between an anode and a cathode. The electrolyte membrane that is used in the hydrogen compression device 18 is a proton exchange membrane. An electrical power source 19 is connected to the anode and the cathode.

The control device 28 is capable of varying the voltage of the electrical power source (power source) 19 that is applied between the anode and the cathode. The electrical power of the electrical power source 19 may also utilize the electrical power of the battery 23.

The hydrogen compression device 18 supplies the hydrogen gas that flows in from the hydrogen supply path 32, to the anode. The hydrogen compression device 18 ionizes the hydrogen gas based on the voltage applied from the electrical power source 19. Protons, which are obtained by ionizing the hydrogen gas, reach the cathode via an electrolyte membrane (the proton exchange membrane). The protons that have reached the cathode combine with the electrons (the electrons generated at the time of the ionization) supplied from the electrical power source 19, and are returned to the hydrogen gas.

The hydrogen compression device 18, by transferring the protons from the anode to the cathode, generates a pressurized hydrogen gas. For example, the hydrogen gas is compressed to a pressure in a range of from 1 to 100 MPa. In this manner, the hydrogen compression device 18 is an electrochemical hydrogen compressor (EHC: Electrochemical Hydrogen Compressor) that electrochemically compresses the hydrogen gas.

The hydrogen compression device 18 outputs surplus hydrogen gas that has not been ionized, to the hydrogen discharge path 35. The hydrogen discharge path 35 serves as a flow path (a pipe) in order to discharge the hydrogen gas from the hydrogen compression device 18 into the gas-liquid separator 14.

The hydrogen compression device 18 outputs a released gas containing the pressurized hydrogen gas to a hydrogen supply mechanism 17B. Moreover, the released gas contains water vapor that is vaporized by the heat of the hydrogen compression device 18 or the like.

The oxygen supply mechanism 17A and the hydrogen supply mechanism 17B constitute a gas supply mechanism 17. The gas supply mechanism 17 is a mechanism for supplying reaction gases (hydrogen gas and oxygen gas) to the fuel cell 22.

The oxygen supply mechanism 17A supplies the oxygen gas generated in the water electrolysis device 12 to the fuel cell 22. The hydrogen supply mechanism 17B supplies the hydrogen gas generated in the hydrogen compression device 18 to the fuel cell 22.

### [Description of Oxygen Supply Mechanism 17A]

The oxygen supply mechanism 17A includes the oxygen supply path 43, the oxygen tank 16, a bypass path 45, an on-off valve 47, an on-off valve 49, a pressure reducing valve (supply pressure reducing valve) 51, a pressure reducing valve 53, a pressure reducing valve (bypass pressure reducing valve) 58, a back pressure valve 57, a pressure sensor 61, a temperature sensor 63, and a gas-liquid separator 15.

The oxygen supply path 43 is a flow path in order to supply the high pressure oxygen gas generated in the water electrolysis device 12, via the oxygen tank 16, to the fuel cell 22. One end of the oxygen supply path 43 is connected to the water electrolysis device 12, and the other end of the oxygen supply path 43 is connected, via the pressure reducing valve 53, to the fuel cell 22.

The oxygen tank 16 is disposed on the oxygen supply path 43. The oxygen tank 16 stores therein the high pressure oxygen gas generated by the water electrolysis device 12

The bypass path 45 branches off from a branching portion Bpo (BP) of the oxygen supply path 43 between the back pressure valve 57 and the gas-liquid separator 15, and merges with a merging portion Mpo (MP) of the oxygen supply path 43 between the oxygen tank 16 and the fuel cell 22.

The on-off valve 47 is disposed in the bypass path 45. The on-off valve 49 is disposed in the oxygen supply path 43 between the merging portion Mpo and the oxygen tank 16.

Each of the on-off valves 47 and 49 is an electromagnetic valve, and is a shutoff valve that is opened and closed by an ON/OFF control of the control device 28.

The pressure reducing valve 51 is disposed in the oxygen supply path 43 between the merging portion Mpo and the oxygen tank 16. The pressure reducing valve 51 reduces to a predetermined pressure the pressure of the oxygen gas that is supplied from the oxygen tank 16.

The pressure reducing valve 53 is disposed in the oxygen supply path 43 between the merging portion Mpo and the fuel cell 22. The pressure reducing valve 53 reduces to a predetermined pressure the pressure of the oxygen gas that is supplied from the pressure reducing valve 51 or the bypass path 45.

The back pressure valve 57 is disposed in the oxygen supply path 43 between the branching portion Bpo and the oxygen tank 16. The back pressure valve 57 applies a pressure (a back pressure) to the water electrolysis device 12 through a gas space of the gas-liquid separator 15. In accordance with this feature, the pressure of the oxygen gas that is generated at the anode of each of the unit cells of the water electrolysis device 12 rises, and becomes higher in pressure than the pressure of the hydrogen gas that is generated at the cathode.

The water electrolysis device 12 generates at the anode the oxygen gas, the pressure of which is higher than that of the hydrogen gas that is generated at the cathode.

Accordingly, cross-leaking, by which the hydrogen gas permeates through the electrolyte membrane from the cathode toward the anode, can be suppressed. As a result, a reduction in the amount of the hydrogen gas supplied from the water electrolysis device 12 to the hydrogen compression device 18 can be prevented.

The pressure sensor 61 is provided in the oxygen supply path 43 between the water electrolysis device 12 and the branching portion Bpo. The pressure sensor 61 detects the pressure of the oxygen gas that is supplied from the water electrolysis device 12 to the oxygen supply path 43. The pressure sensor 61 outputs to the control device 28 a signal indicative of the detected pressure.

The temperature sensor 63 is provided in the oxygen supply path 43 between the water electrolysis device 12 and the gas-liquid separator 15. The temperature sensor 63 detects the temperature of the oxygen gas that is supplied from the water electrolysis device 12 to the oxygen supply path 43. The temperature sensor 63 outputs to the control device 28 a signal indicative of the detected temperature. The gas-liquid separator 15 is provided on the oxygen supply path 43 between the water electrolysis device 12 and the branching portion Bpo.

The oxygen gas that is discharged from the water electrolysis device 12 into the oxygen supply path 43 contains water vapor in addition to the oxygen gas. The gas-liquid separator 15 cools the water vapor within the released gas to thereby generate liquid water, and supplies the oxygen gas from which the water has been removed, to the oxygen tank 16. In accordance with this feature, it is possible to suppress the occurrence of a state in which the oxygen tank 16 becomes damp. As a result, the durability of the oxygen tank 16 can be enhanced without requiring the implementation of an excessive rust-proofing process to the oxygen tank 16.

The gas-liquid separator 15 is connected, via a liquid water supply path 65, to the gas-liquid separator 14. The liquid water supply path 65 is a flow path (communication path) in order to supply the liquid water stored in the gas-liquid separator 15 to the gas-liquid separator 14. A drain valve 64, which is an on-off valve, is disposed on the liquid water supply path 65.

The liquid water, which is obtained from the water vapor within the oxygen gas released from the water electrolysis device 12, is supplied, via the drain valve 64 and the liquid water supply path 65, from the gas-liquid separator 15 to the gas-liquid separator 14. Thus, the amount of water used in the water electrolysis device 12 can be saved. The gas-liquid separator 14 stores the water that is supplied to the water electrolysis device 12. The water supply path 30 is disposed between the gas-liquid separator 14 and the water electrolysis device 12. A pump 31 is disposed on the water supply path 30.

### [Description of Hydrogen Supply Mechanism 17B]

The hydrogen supply mechanism 17B includes a hydrogen supply path 44, the hydrogen tank 20, a bypass path 46, an on-off valve 48, an on-off valve 50, a pressure reducing valve (supply pressure reducing valve) 52, a pressure reducing valve 54, a pressure reducing valve (bypass pressure reducing valve) 56, a back pressure valve 59, a pressure sensor 62, and a temperature sensor 69.

The hydrogen supply path 44 is a flow path in order to supply to the fuel cell 22, via the hydrogen tank 20, the hydrogen gas that has been pressurized by the hydrogen compression device 18. One end of the hydrogen supply path 44 is connected to the hydrogen compression device 18, and the other end of the hydrogen supply path 44 is connected, via the pressure reducing valve 54, to the fuel cell 22.

The hydrogen tank 20 is disposed on the hydrogen supply path 44. The hydrogen tank 20 stores the high pressure hydrogen gas pressurized by the hydrogen compression device 18.

The bypass path 46 branches off from a branching portion Bph (BP) of the hydrogen supply path 44 between the hydrogen compression device 18 and the hydrogen tank 20, and merges with a merging portion Mph (MP) of the hydrogen supply path 44 between the hydrogen tank 20 and the fuel cell 22.

The on-off valve 48 is disposed in the bypass path 46. The on-off valve 50 is disposed in the hydrogen supply path 44 between the merging portion Mph and the hydrogen tank 20.

Each of the on-off valves 48 and 50 is an electromagnetic valve, and is a shutoff valve that is opened and closed by an ON/OFF control of the control device 28.

The pressure reducing valve 52 is disposed in the hydrogen supply path 44 between the merging portion Mph and the hydrogen tank 20. The pressure reducing valve 52 reduces to a predetermined pressure the pressure of the hydrogen gas that is supplied from the hydrogen tank 20.

The pressure reducing valve 54 is disposed in the hydrogen supply path 44 between the merging portion Mph and the fuel cell 22. The pressure reducing valve 54 reduces to a predetermined pressure the pressure of the hydrogen gas that is supplied from the pressure reducing valve 52 or the bypass path 46.

The back pressure valve 59 is disposed in the hydrogen supply path 44 between the branching portion Bph and the hydrogen tank 20. The back pressure valve 59 applies a pressure (a back pressure) to the hydrogen compression device 18. In accordance with this feature, the pressure of the hydrogen gas that is generated at the cathode of each of the unit cells of the hydrogen compression device 18 rises, and becomes higher in pressure than the pressure of the hydrogen gas that is supplied to the anode.

The pressure sensor 62 is disposed in the hydrogen supply path 44 between the hydrogen compression device 18 and the branching portion Bph. The pressure sensor 62 detects the pressure of the hydrogen gas that is supplied to the hydrogen supply path 44. The pressure sensor 62 outputs to the control device 28 a signal indicative of the detected pressure.

The temperature sensor 69 is disposed in the hydrogen supply path 44 between the hydrogen compression device 18 and the branching portion Bph. The temperature sensor 69 detects the temperature of the hydrogen gas that is supplied from the hydrogen compression device 18 to the hydrogen supply path 44. The temperature sensor 69 outputs to the control device 28 a signal indicative of the detected temperature.

### [Description of Fuel Cell 22]

The oxygen supply mechanism 17A further includes an oxygen exhaust gas path 76, a gas-liquid separator 24, a circulation pump 70, and a drain valve 72.

The hydrogen supply mechanism 17B further includes a hydrogen exhaust gas path 77, a gas-liquid separator 26, a circulation pump 71, and a drain valve 73.

The fuel cell 22 includes a stack made up from a plurality of unit cells that are electrically connected in series. Each of the unit cells includes a membrane electrode assembly (MEA) in which an electrolyte membrane is sandwiched and held between an anode and a cathode.

The fuel cell 22 supplies the oxygen gas, which is supplied from the oxygen tank 16, via the pressure reducing valves 51 and 53, to the cathode of each of the unit cells. The fuel cell 22 supplies the hydrogen gas, which is supplied from the hydrogen tank 20, via the pressure reducing valve 52 and the pressure reducing valve 54, to the anode of each of the unit cells. Each of the unit cells of the fuel cell 22 generates power by means of an electrochemical reaction between the oxygen gas and the hydrogen gas.

The generated power of the fuel cell 22 is supplied to a non-illustrated load (a main load) and is also supplied to an auxiliary load including the control device 28. A surplus portion of the generated power is charged into the battery 23. A power generation current Ifc of the fuel cell 22 is detected by an electrical current sensor 27, and is acquired by the control device 28. The stored voltage of the battery 23 and the generated voltage of the fuel cell 22 are detected by non-illustrated voltage sensors, and are acquired by the control device 28.

An oxygen-containing exhaust gas, which contains an unreacted oxygen gas in each of the unit cells of the fuel cell 22, is supplied, via an oxygen circulation path 66, to the oxygen supply path 43. The oxygen circulation path 66 is a flow path for returning the oxygen-containing exhaust gas, which is discharged from the fuel cell 22, to the oxygen supply path 43.

The gas-liquid separator 24 and the circulation pump 70 are disposed on the oxygen circulation path 66. The gas-liquid separator 24 separates the oxygen-containing exhaust gas, which is discharged from the fuel cell 22 into the oxygen exhaust gas path 76, into a gas component (oxygen gas and water vapor) and a liquid component (liquid water). The gas component is resupplied to the fuel cell 22 by the circulation pump 70. On the other hand, the liquid component is supplied, via the drain valve 72 which is an on-off valve, into the water tank 21.

On the other hand, a hydrogen-containing exhaust gas, which contains an unreacted hydrogen gas in each of the unit cells of the fuel cell 22, is supplied, via a hydrogen circulation path 67, to the hydrogen supply path 44. The hydrogen circulation path 67 is a flow path in order to return the hydrogen-containing exhaust gas, which is discharged from the fuel cell 22, to the hydrogen supply path 44.

The gas-liquid separator 26 and the circulation pump 71 are disposed on the hydrogen circulation path 67. The gas-liquid separator 26 separates the hydrogen-containing exhaust gas, which is discharged from the fuel cell 22 into the hydrogen exhaust gas path 77, into a gas component (hydrogen gas and water vapor) and a liquid component (liquid water). The gas component is resupplied to the fuel cell 22 by the circulation pump 71. On the other hand, the liquid component is supplied, via the drain valve 73 which is an on-off valve, into the water tank 21.

### [Description of the Control Device 28]

The control device 28 controls all of the constituent elements of the regenerative fuel cell system 10, and executes the operation of the regenerative fuel cell system 10.

The control device 28 is a computer that controls the regenerative fuel cell system 10. The control device 28 includes one or more processors, and a storage medium. The storage medium may be constituted by a volatile memory and a non-volatile memory. As the processor, there may be cited a CPU, an MCU, or the like. As the volatile memory, there may be cited, for example, a RAM or the like. As the non-volatile memory, there may be cited, for example, a ROM, a flash memory, or the like.

The control device 28 turns ON the electrical power source 13 of the water electrolysis device 12, and thereby applies a voltage to the anode and the cathode of each of the unit cells. In addition thereto, the control device 28 turns ON the pump 31, and thereby supplies the water from the gas-liquid separator 14 to the water electrolysis device 12.

In accordance with this feature, the water electrolysis device 12 enters into an operating state (a pressurizing state, a water electrolysis state), and carries out electrolysis (water electrolysis) of water.

When the control device 28 stops applying the voltage from the electrical power source 13 to the unit cells and stops supplying the water to the water electrolysis device 12, the water electrolysis device 12 becomes placed in a non-operating state (i.e., to a stopped state through a depressurized state).

Further, the control device 28 turns ON the electrical power source 19 of the hydrogen compression device 18, and thereby applies a voltage to the anode and the cathode of each of the unit cells. In addition thereto, the control device 28 turns ON the pump 34, and thereby supplies the hydrogen gas from the gas-liquid separator 14 to the hydrogen compression device 18.

In accordance with this feature, the hydrogen compression device 18 enters into an operating state (a pressurizing state), and thereby pressurizes the hydrogen gas. When the control device 28 stops applying the voltage from the electrical power source 19 to the unit cells and stops supplying the hydrogen to the hydrogen compression device 18, the hydrogen compression device 18 becomes placed in a non-operating state (i.e., to a stopped state through a depressurized state).

### [Description of Operations of Regenerative Fuel Cell System 10]

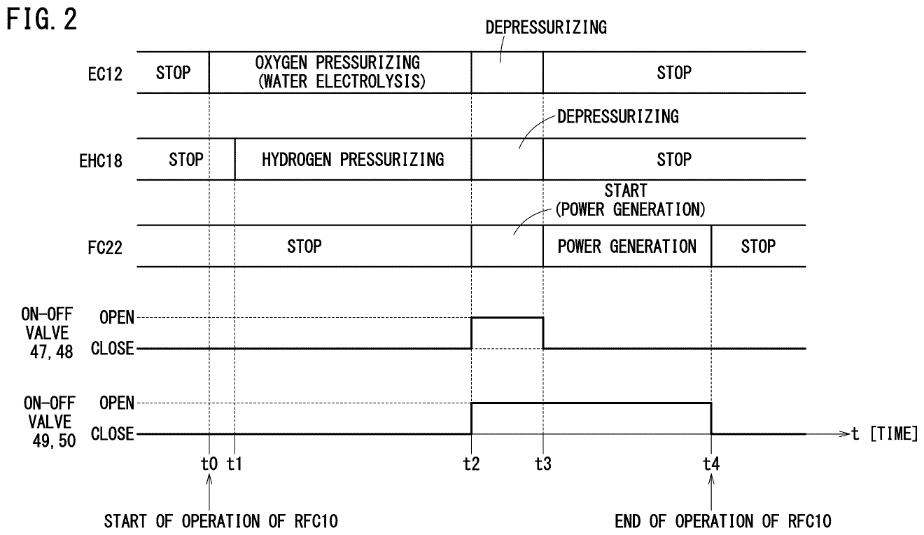

Basically, the operation of the regenerative fuel cell system 10, which is configured in the manner described above, will be described below with reference to the time chart (sequence of operations) shown in FIG. 2.

In FIG. 2, EC12 indicates the water electrolysis device 12, EHC18 indicates the hydrogen compression device 18, FC22 indicates the fuel cell 22, and RFC10 indicates the regenerative fuel cell system 10.

The regenerative fuel cell system 10 according to the present embodiment executes a characteristic depressurizing process (processing from time t2 to time t3), which will be described in detail below.

In order to facilitate understanding of the depressurizing process, initially, the oxygen pressurizing (the water electrolysis) process and the hydrogen pressurizing process from time to up to time t2 will be described.

At a point in time immediately prior to time to, the fuel cell 22, the water electrolysis device 12, and the hydrogen compression device 18 are stopped, and thus the regenerative fuel cell system 10 is stopped. In the state in which the regenerative fuel cell system 10 is stopped, the on-off valve 47, the on-off valve 48, the on-off valve 49, and the on-off valve 50, each of which are shutoff valves in order to supply the oxygen gas and the hydrogen gas to the fuel cell 22, are closed.

At time to, the operation of the regenerative fuel cell system 10 is started. In this case, the control device 28, initially, turns ON the pump 25 and the pump 31, and thereby supplies the water stored in the water tank 21 to the cathode of each of the unit cells of the water electrolysis device 12, through the water supply path 29, the gas-liquid separator 14, and the water supply path 30.

The control device 28, next, supplies a predetermined electrical current from the electrical power source 13 to the cathode and the anode of each of the unit cells of the water electrolysis device 12, and thereby initiates the pressurizing operation of the water electrolysis device 12.

In this case, the oxygen gas which has been increased in pressure is generated by the electrolysis of water at the anodes. The oxygen gas is supplied, via the oxygen supply path 43 of the oxygen supply mechanism 17A, to the oxygen tank 16 of the oxygen supply mechanism 17A. The reaction formula on the anode side of the water electrolysis device 12 is shown below.

2OH⁻→(½)O₂+H₂O+2e⁻

When the water electrolysis device 12 starts the pressurizing operation, hydrogen gas is generated by the electrolysis of water at the cathodes. The hydrogen gas is released from the water electrolysis device 12, and is supplied, via the pump 34 that has been turned ON and the hydrogen supply path 32, to the anode of each of the unit cells of the hydrogen compression device 18. The reaction formula on the cathode side of the water electrolysis device 12 is shown below.

2H₂O+2e⁻→H₂+2OH⁻

The control device 28 confirms the supply of the hydrogen gas to the hydrogen supply path 32, based on the pressure detected by the pressure sensor 60 disposed in the hydrogen supply path 32.

When the supply of the hydrogen gas to the hydrogen supply path 32 is confirmed, then at time t1, the control device 28 controls the electrical power source 19, and thereby causes the hydrogen compression device 18 to execute the pressurizing operation. When the hydrogen compression device 18 starts the pressurizing operation, the hydrogen gas pressurized by the hydrogen gas being ionized is generated at the cathode. This high pressure hydrogen gas is supplied to the hydrogen tank 20 via the hydrogen supply path 44 of the hydrogen supply mechanism 17B. The reaction formula on the cathode side of the hydrogen compression device 18 is shown below.

2H⁺+2e⁻→H₂

The reaction formula on the anode side of the hydrogen compression device 18 is shown below.

H₂→2H⁺+2e⁻

At time t2, by means of the water electrolysis process and the hydrogen pressurizing process from time t1 to time t2, when a predetermined amount of the hydrogen and a predetermined amount of the oxygen are stored respectively in the hydrogen tank 20 and the oxygen tank 16, then the depressurizing process by the control device 28 is started at time t2.

### [Detailed Description of Depressurizing Process]

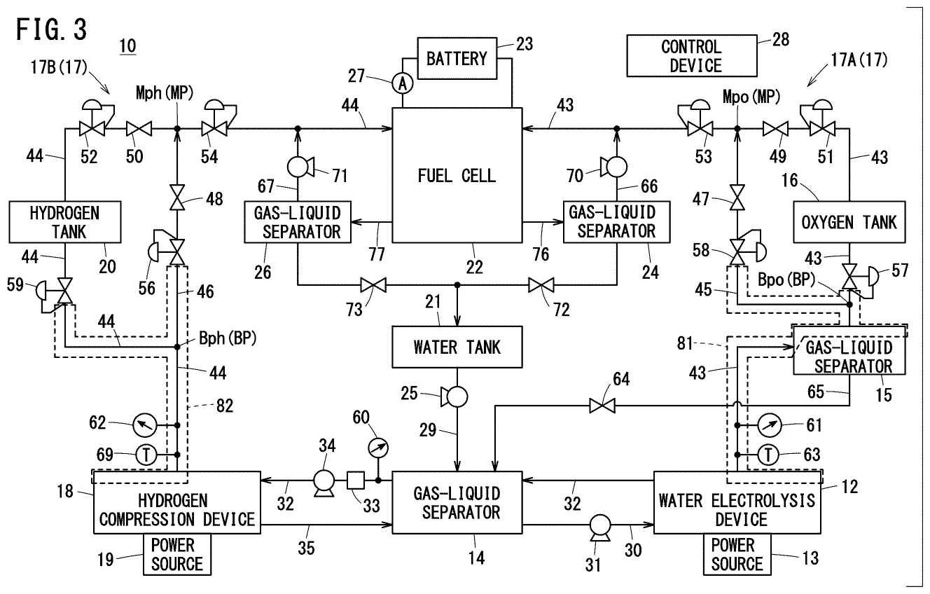

FIG. 3 is an explanatory diagram schematically showing the regions (an oxygen depressurizing region 81 and a hydrogen depressurizing region 82, which are the gas depressurizing regions surrounded respectively by dashed lines) to be subjected to the depressurizing process.

On the oxygen supply side, a region including a portion of the oxygen supply path 43 up to a primary side of the back pressure valve 57 communicating with the anode of the water electrolysis device 12 and a portion of the bypass path 45 up to a primary side of the pressure reducing valve 58 communicating with the anode of the water electrolysis device 12 correspond to the oxygen depressurizing region 81. The oxygen depressurizing region 81 is a region in which the high pressure oxygen gas exists, in a flow path (a space) from the anode of the water electrolysis device 12 up to the merging portion Mpo, at a time when the water electrolysis device 12 stops the pressurizing operation.

On the hydrogen supply side, a region including a portion of the hydrogen supply path 44 up to a primary side of the back pressure valve 59 communicating with the cathode of the hydrogen compression device 18 and a portion of the bypass path 46 up to a primary side of the pressure reducing valve 56 communicating with the cathode of the hydrogen compression device 18 correspond to the hydrogen depressurizing region 82.

Hereinafter, concerning the depressurizing process (depressurizing step), a description thereof will be presented in the following order: A. First Depressurizing Method (Method for Solving the First Problem); B. Second Depressurizing Method (Method for Solving the Second Problem); and C. Third Depressurizing Method (Method for Solving the Third Problem).

### A. First Depressurizing Method (Method for Solving the First Problem)

The aforementioned [First Problem] is that it is difficult to control the target depressurization rate (the decompression rate) of the oxygen gas and the hydrogen gas on which depressurization thereof is attempted.

In the first depressurizing method, the power generation current Ifc is controlled by the control device 28 in accordance with the following calculations. In the first depressurizing method, the depressurization rate can be controlled accurately and precisely by controlling the power generation current Ifc, which is easy to control. The hydrogen gas consumption amount by the fuel cell 22 can be calculated by the following equation (1).

$$Hydrogen Gas Consumption Amount [ mol / sec ] = Ifc [ A ] / ( 2 \times F [ C / mol ] ) \qquad ( 1 )$$

wherein F is Faraday's Constant=9.65×10⁴ [C/mol].

The hydrogen-side depressurization rate (hydrogen-side decompression rate) [kpA/sec] corresponding to the target depressurization rate in the hydrogen depressurizing region 82 can be calculated by the following equation (2). In the equation, the volume of the hydrogen depressurizing region 82 (hydrogen-side volume [mL]) is already known based on the design and actual measurements.

$$Hydrogen - Side Depressurization Rate [ kpA / sec ] = Hydrogen Gas Consumption Amount [ mol / sec ] \times R \times Gas Temperature [ K ] \times Z / Hydrogen - Side Volume [ mL ] \qquad ( 2 )$$

wherein R is the gas constant and Z is the compressibility factor. The compressibility factor Z will be briefly described as follows. In an ideal gas, the volume occupied by molecules and the existence of the attractive forces between molecules are ignored, however, when the gas pressure is in a high pressure state (in a real gas), such attractive forces between molecules exist, and the volume occupied by the molecules cannot be ignored. The compressibility factor Z is defined as Z=PV/(nRT), i.e., a factor that corrects for the effects of the attractive forces between molecules and the volume occupied by the molecules. Since the compressibility factor Z varies depending on parameters such as the type of gas, the number of moles n, the pressure P, the temperature T, and the volume V, the compressibility factor Z is obtained in advance by varying these parameters.

The oxygen gas consumption amount by the fuel cell 22 can be calculated by the following equation (3).

$$Oxygen Gas Consumption Amount [ mol / sec ] = Ifc [ A ] / ( 4 \times F [ C / mol ] ) \qquad ( 3 )$$

The oxygen-side depressurization rate (oxygen-side depressurization rate) [kpA/sec] corresponding to the target depressurization rate in the oxygen depressurizing region 81 can be calculated by the following equation (4). In the equation, the volume of the oxygen depressurizing region 81 (oxygen-side volume [mL]) is already known based on the design and actual measurements.

$$Oxygen - Side Depressurization Rate [ kpA / sec ] = Oxygen Gas Consumption Amount [ mol / sec ] \times R \times Gas Temperature [ K ] \times Z / Oxygen - Side Volume [ mL ] \qquad ( 4 )$$

Since the compressibility factor Z varies depending on parameters such as the type of gas, the number of moles n, the pressure P, the temperature T, and the volume V, the compressibility factor Z is obtained in advance by varying these parameters.

In this case, the hydrogen-side depressurization rate or the oxygen-side pressurization rate is set in a manner so that the power generation current Ifc, which is calculated by substituting equation (2) into equation (1), and the power generation current Ifc, which is calculated by substituting equation (4) into equation (3), are the same value.

In the actual depressurizing process, as shown in FIG. 2, after time t2, all of the on-off valves 47 to 50 are opened and the power generation current Ifc can be controlled by the control device 28. Thus, the aforementioned first problem can be easily solved.

Moreover, instead of the aforementioned calculations, a relationship between the power generation current Ifc and the depressurization rate may be actually measured in advance, and may be stored as a relationship characteristic in a non-illustrated storage device inside the control device 28. The control device 28 may refer to the relationship characteristic based on the depressurization rate, and may thereby determine the power generation current Ifc.

In practice, it is preferable for the control device 28 to calculate the depressurization rate (pressure reducing value per unit time: measured depressurization rate) of the pressure values detected by the pressure sensors 61 and 62, and to adjust the power generation current Ifc by way of a feedback control, in a manner so that the difference from the target depressurization rate becomes small.

### B. Second Depressurizing Method (Method for Solving the Second Problem)

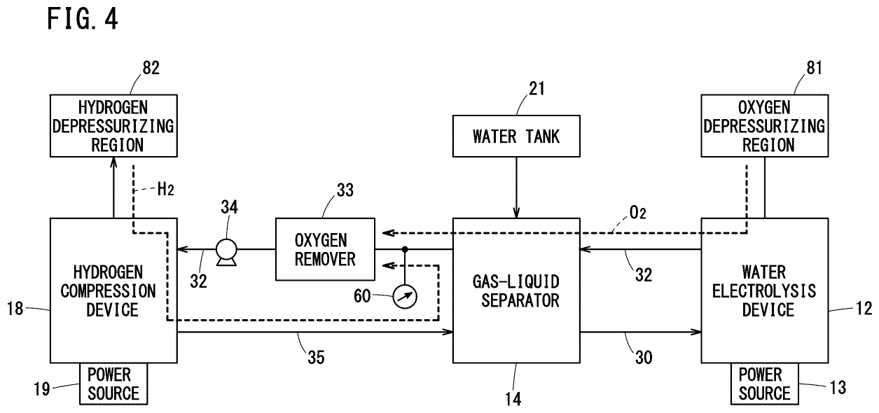

A description will be given with reference to the schematic diagram shown in FIG. 4. During the depressurizing process in the aforementioned first depressurizing method (the method for solving the first problem), a pressure difference is generated between the electrolyte membranes of the stacks of the water electrolysis device 12 and the hydrogen compression device 18. Therefore, cross-leaking (cross-leaking of the oxygen permeating in a reverse direction through the electrolyte membrane, and cross-leaking of the hydrogen permeating in a reverse direction through the electrolyte membrane), as shown by the thick dashed lines in FIG. 4, occurs from the high pressure side to the low pressure side of each of the stacks of the water electrolysis device 12 and the hydrogen compression device 18. The cross-leaked oxygen and the cross-leaked hydrogen must be subjected to a depressurizing process (disposal).

Concerning the cross-leaking of the oxygen in the water electrolysis device 12, as shown in FIG. 4, the hydrogen remaining in the gas-liquid separator 14 and the cross-leaked hydrogen supplied from the hydrogen compression device 18 through the hydrogen discharge path 35 to the gas-liquid separator 14, and the cross-leaked oxygen supplied from the water electrolysis device 12 through the hydrogen supply path 32 to the gas-liquid separator 14 are made to react with each other in the oxygen remover 33 which is equipped with an oxygen removal catalyst, to thereby be converted into water, and thus the depressurizing is achieved.

For carrying out the reaction in the oxygen remover 33, the pump 34 is turned ON, and the oxygen and the hydrogen that have cross-leaked are made to flow through the hydrogen supply path 32.

In general, concerning the cross-leaking of the oxygen and the cross-leaking of the hydrogen, the cross-leaking becomes greater for the hydrogen whose molecules are smaller. Therefore, the hydrogen remains on the primary side of the hydrogen compression device 18 which communicates with the hydrogen discharge path 35, and more specifically, the hydrogen remains in the gas-liquid separator 14 and the pressure rises.

Thus, concerning the remaining hydrogen, during the depressurizing control, an electrical current is applied from the electrical power source 19 to the hydrogen compression device 18, and the remaining hydrogen is boosted in pressure to a high pressure. The high pressure hydrogen, which has been boosted in pressure, can be consumed by a third depressurizing method described below.

In practice, the current flowing from the electrical power source 19 to the hydrogen compression device 18 may be determined in a manner so that any deviation between the pressure value detected by the pressure sensor 60 (the pressure value of the gas-liquid separator 14) and the target pressure value (the target pressure value which is the allowable pressure value of the gas-liquid separator 14) becomes zero.

### C. Third Depressurizing Method (Method for Solving the Third Problem)

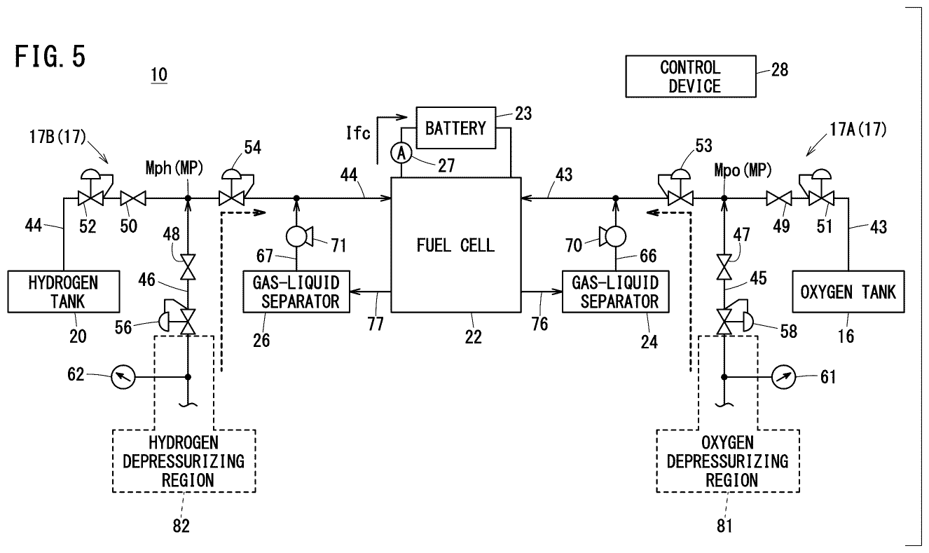

(1) FIG. 5 is a schematic explanatory diagram for providing a description of the third depressurizing method (1) in which the oxygen in the oxygen depressurizing region 81 and the hydrogen in the hydrogen depressurizing region 82 are consumed preferentially in the fuel cell 22.

In the third depressurizing method (1), for the oxygen depressurizing region 81, the control device 28 adjusts the pressure reducing valve 51 and the pressure reducing valve 58 in a manner so that a set pressure Psc of the pressure reducing valve 51 becomes lower than a set pressure Psd of the pressure reducing valve 58 (Psc<Psd).

Due to these settings, only the high pressure oxygen remaining in the oxygen depressurizing region 81 flows into the fuel cell 22 through the pressure reducing valve 58 and the bypass path 45, as shown by the thick dashed line in FIG. 5, and the oxygen does not flow through a portion of the oxygen supply path 43 in which the pressure reducing valve 51 is provided. More specifically, only the oxygen in the oxygen depressurizing region 81, which is the region in which the depressurizing process is required, is consumed by the fuel cell 22. In accordance with this feature, a complicated opening and closing control of the on-off valve 47 and the on-off valve 49 at the time of the depressurizing process as in the conventional method becomes unnecessary. As can be understood from the depressurizing process period from time t2 to time t3 in FIG. 2, both the on-off valve 47 and the on-off valve 49 are maintained in the open state during that period.

At the same time, in the third depressurizing method, for the hydrogen depressurizing region 82, the control device 28 adjusts the pressure reducing valve 52 and the pressure reducing valve 56 in a manner so that a set pressure Psa of the pressure reducing valve 52 becomes lower than a set pressure Psb of the pressure reducing valve 56 (Psa<Psb).

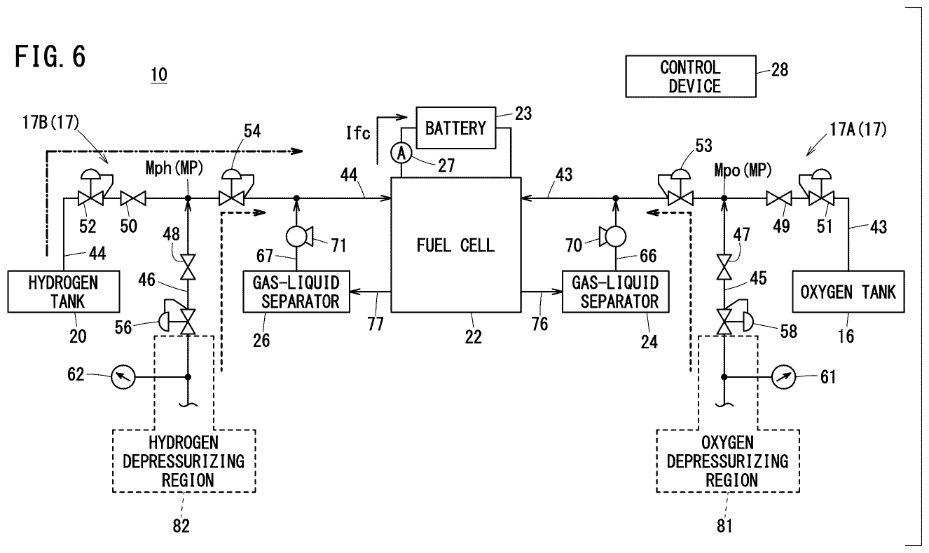

Due to these settings, only the high pressure hydrogen remaining in the hydrogen depressurizing region 82 flows into the fuel cell 22 through the pressure reducing valve 56 and the bypass path 46, as shown by the thick dashed line in FIG. 5, and the hydrogen does not flow through a portion of the hydrogen supply path 44 in which the pressure reducing valve 52 is provided. More specifically, only the hydrogen in the hydrogen depressurizing region 82, which is the region in which the depressurizing process is required, is consumed by the fuel cell 22. In accordance with this feature, a complicated control of the on-off valve 48 and the on-off valve 50 as in the conventional method becomes unnecessary. As can be understood from the depressurizing process period from time t2 to time t3 in FIG. 2, both the on-off valve 48 and the on-off valve 50 are maintained in the open state during that period. The control device 28 charges the battery 23 with the generated electrical power generated by the oxygen and the hydrogen that have been consumed in the fuel cell 22 during the depressurizing process from time t2 to time t3.
(2) FIG. 6 is a schematic explanatory diagram for providing a description of the third depressurizing method (2) in which the oxygen in the oxygen depressurizing region 81 and the hydrogen in the hydrogen depressurizing region 82 are consumed preferentially in the fuel cell 22.

When the aforementioned third depressurizing method (1) is executed, the hydrogen in the hydrogen depressurizing region 82 is completely consumed earlier than the oxygen in the oxygen depressurizing region 81, due to the fact that 2 [mol] of the hydrogen are consumed with respect to every 1 [mol] of the oxygen by means of the electrochemical reaction (2H₂+O₂→2H₂O) in the fuel cell 22.

Thus, in that case, the control device 28 adjusts the set pressure Psa of the pressure reducing valve 52, in a manner so that the set pressure Psa of the pressure reducing valve 52 becomes the pressure measured by the pressure sensor 62 in the hydrogen depressurizing region 82.

Owing to the above, as shown by the thick dashed-dotted line in FIG. 6, when the hydrogen inside the hydrogen depressurizing region 82 alone is not enough, hydrogen can be supplied from the hydrogen tank 20 to the fuel cell 22 so as to compensate for the deficiency of hydrogen. In this case, the electrochemical reaction in the fuel cell 22 is continued, and the high pressure oxygen in the oxygen depressurizing region 81 can be entirely consumed. Incidentally, depending on the ratio of the volumes between the oxygen depressurizing region 81 and the hydrogen depressurizing region 82 and the ratio of the pressures between the oxygen depressurizing region 81 and the hydrogen depressurizing region 82, the oxygen in the oxygen depressurizing region 81 may be completely consumed earlier than the hydrogen in the hydrogen depressurizing region 82. In this case as well, by means of a similar approach, the electrochemical reaction in the fuel cell 22 is continued, and the high pressure hydrogen in the hydrogen depressurizing region 82 can be entirely consumed. The foregoing is a detailed description of the depressurizing process.

Moreover, as shown in FIG. 2, at time t3 which is a point in time when the depressurizing process is completed, the on-off valve 47 of the bypass path 45 and the on-off valve 48 of the bypass path 46 are closed. Thereafter, from time t3 to time t4, the power generating operation of the fuel cell 22 is executed using the oxygen gas and the hydrogen gas that are stored in the oxygen tank 16 and the hydrogen tank 20. When the power generating operation of the fuel cell 22 is stopped at time t4, the operation of the regenerative fuel cell system comes to an end.

Concerning the above-described embodiment, the following supplementary notes are further disclosed.

### (Supplementary Note 1)

In the regenerative fuel cell system (10) including the fuel cell (22) that carries out the power generation by an electrochemical reaction between the oxygen gas and the hydrogen gas, the regenerative fuel cell system includes the compression device (18, 12) that generates either one of the pressurized oxygen gas or the pressurized hydrogen gas, the supply mechanism (17, 17A, 17B) that supplies the gas to the fuel cell, and the control device (28), wherein the supply mechanism includes the gas supply path (43, 44) that supplies the gas from the compression device to the fuel cell, the tank (16, 20) disposed on the gas supply path, and which stores the gas that has been pressurized by the compression device, the bypass path (45, 46) that branches off from the branching portion (BP) of the gas supply path between the compression device and the tank, and merge into the merging portion (MP) of the gas supply path between the tank and the fuel cell, the supply pressure reducing valve (51, 52) disposed in the gas supply path between the tank and the merging portion, the bypass pressure reducing valve (56, 58) disposed in the bypass path, and the on-off valve (47, 48, 49, 50) that allows the gas to be supplied to the fuel cell, wherein the control device, in the case that the pressurizing stop operation by the compression device is started, stops the supply of the gas to the tank and place the on-off valve in the valve open state, and lowers the set pressure of the supply pressure reducing valve (51, 52) when in the valve open state to be lower than the set pressure of the bypass pressure reducing valve (56, 58), and executes a depressurizing process of the compression device.

In the foregoing manner, when executing the depressurizing process of the compression device, by a simple method of placing the on-off valve in the opened state and setting the set pressure of the supply pressure reducing valve to be lower than the set pressure of the bypass pressure reducing valve, the gas that remains in the gas depressurizing region can be supplied, via the bypass pressure reducing valve, to the fuel cell.

### (Supplementary Note 2)

In the regenerative fuel cell system according to Supplementary Note 1, the control device, during execution of the depressurizing process, may calculate the power generation current of the fuel cell based on the gas consumption amount, and may control the depressurization rate at the time of the depressurizing process.

In this case, by controlling the power generation current, the amount of gas that is consumed can be controlled with high precision. Therefore, the depressurizing process can be executed at an accurate depressurization rate (decompression rate).

### (Supplementary Note 3)

In the regenerative fuel cell system according to Supplementary Note 1, the control device, during execution of the depressurizing process, may determine the power generation current of the fuel cell by referring to the relationship characteristic between the power generation current of the fuel cell and the depressurization rate at the time of the depressurizing process, the relationship characteristic being actually measured and stored in advance. In accordance with this feature, it is possible to more easily determine the power generation current that controls the depressurization rate.

### (Supplementary Note 4)

The regenerative fuel cell system according to Supplementary Note 1 may further include the pressure sensor (61, 62) provided between the compression device and the branching portion, and the control device, during execution of the depressurizing process, may measure the depressurization rate by way of the pressure sensor to thereby obtain the measured depressurization rate, and may adjust the power generation current of the fuel cell, in a manner so that the difference between the measured depressurization rate and the target depressurization rate becomes small. In accordance with this feature, it is possible to more easily adjust the power generation current that controls the depressurization rate.

### (Supplementary Note 5)

The regenerative fuel cell system according to Supplementary Note 1 may further the gas-liquid separator (14) to which the gas that has not been pressurized by the compression device, and the water that has been generated by the power generation by the fuel cell are supplied, and the oxygen remover (33) disposed between the gas-liquid separator and the compression device, wherein the control device, during execution of the depressurizing process, may cause the hydrogen gas and the oxygen gas that have cross-leaked from the compression device to the gas-liquid separator, to react with each other in the oxygen remover, and thereby produce water.

In accordance with this feature, since the hydrogen gas and the oxygen gas that have cross-leaked through the electrolyte membrane of the compression device at the time of the depressurizing process, are made to react with each other by way of the catalytic reaction and thereby produce water, the depressurizing process can be reliably carried out.

### (Supplementary Note 6)

In the regenerative fuel cell system according to Supplementary Note 5, the control device, during execution of the depressurizing process, may apply the electrical current to the compression device (18), and may thereby pressurize the hydrogen gas accordingly to the amount of the hydrogen gas that has cross-leaked. In accordance with this feature, the depressurizing process can be carried out more reliably.

### (Supplementary Note 7)

The regenerative fuel cell system according to Supplementary Note 6 may further include the pressure sensor (60) that detects the pressure of the hydrogen gas inside the gas-liquid separator, and the control device may determine the electrical current that is applied to the compression device, based on the feedback control which is carried out in a manner so that the deviation between the pressure value detected by the pressure sensor and the target pressure value is eliminated. In accordance with this feature, it is possible to more reliably execute the depressurizing process of the gas that remains inside the gas-liquid separator.

Although the present disclosure has been described in detail, the present disclosure is not necessarily limited to the specific embodiments described above. These embodiments can be subjected to various additions, substitutions, modifications, partial deletions and the like, within a range that does not depart from the essence and gist of the present disclosure, or alternatively, the essence and gist of the present disclosure as derived from the contents described in the claims and their equivalents. Further, these embodiments can also be implemented in combination. For example, in the above-described embodiments, the order of each of the operations and the order of each of the processes are shown merely as examples, and the present invention is not necessarily limited to these examples. The same applies also in the case that numerical values or mathematical equations are used in the description of the aforementioned embodiments.

1. A regenerative fuel cell system comprising:
a fuel cell configured to carry out power generation by an electrochemical reaction between oxygen gas and hydrogen gas;
a compression device configured to generate either one of a pressurized oxygen gas or a pressurized hydrogen gas;
a supply mechanism configured to supply the gas to the fuel cell; and
a control device,
wherein the supply mechanism comprises:
a gas supply path configured to supply the gas from the compression device to the fuel cell;
a tank disposed on the gas supply path, and configured to store the gas that has been pressurized by the compression device;
a bypass path configured to branch off from a branching portion of the gas supply path between the compression device and the tank, and to merge into a merging portion of the gas supply path between the tank and the fuel cell;
a supply pressure reducing valve disposed in the gas supply path between the tank and the merging portion;
a bypass pressure reducing valve disposed in the bypass path; and
an on-off valve configured to allow the gas to be supplied to the fuel cell,
wherein the control device comprises one or more processors that execute computer-executable instructions stored in a memory, and the one or more processors execute the computer-executable instructions to cause the control device to:
in a case that a pressurizing stop operation by the compression device is started, stop supply of the gas to the tank and place the on-off valve in a valve open state; and
lower a set pressure of the supply pressure reducing valve when in the valve open state to be lower than a set pressure of the bypass pressure reducing valve, and execute a depressurizing process of the compression device.

2. The regenerative fuel cell system according to claim 1, wherein the one or more processors cause the control device to, during execution of the depressurizing process, calculate a power generation current of the fuel cell based on a gas consumption amount, and control a depressurization rate at a time of the depressurizing process.

3. The regenerative fuel cell system according to claim 1, wherein the one or more processors cause the control device to, during execution of the depressurizing process, determine a power generation current of the fuel cell by referring to a relationship characteristic between the power generation current of the fuel cell and a depressurization rate at a time of the depressurizing process, the relationship characteristic being actually measured and stored in advance.

4. The regenerative fuel cell system according to claim 1, further comprising a pressure sensor provided between the compression device and the branching portion,
wherein the one or more processors cause the control device to, during execution of the depressurizing process, measure a depressurization rate by way of the pressure sensor to thereby obtain a measured depressurization rate, and adjust a power generation current of the fuel cell, in a manner so that a difference between the measured depressurization rate and a target depressurization rate becomes small.

5. The regenerative fuel cell system according to claim 1, further comprising:
a gas-liquid separator to which a gas that has not been pressurized by the compression device, and water that has been generated by power generation by the fuel cell are supplied; and
an oxygen remover disposed between the gas-liquid separator and the compression device,
wherein the one or more processors cause the control device to, during execution of the depressurizing process, cause hydrogen gas and oxygen gas that have cross-leaked from the compression device to the gas-liquid separator, to react with each other in the oxygen remover, and thereby produce water.

6. The regenerative fuel cell system according to claim 5, wherein the one or more processors cause the control device to, during execution of the depressurizing process, apply an electrical current to the compression device and thereby pressurize the hydrogen gas accordingly to an amount of the hydrogen gas that has cross-leaked.

7. The regenerative fuel cell system according to claim 6, further comprising a pressure sensor configured to detect a pressure of the hydrogen gas inside the gas-liquid separator,
wherein the one or more processors cause the control device to determine the electrical current that is applied to the compression device, based on a feedback control carried out in a manner so that a deviation between a pressure value detected by the pressure sensor and a target pressure value is eliminated.
